(19) United States
(12) Patent Application Publication
(10) Pub. No.: US 2010/0261834 A1
(43) Pub. Date: Oct. 14, 2010

(54) SHAPE MEMORY RUBBER MOLDED ARTICLE AND PROCESS AND INTERMEDIATE COMPOSITION FOR PRODUCING SAME

(75) Inventors: Shingo Odajima, Tochigi (JP); Minoru Goto, Tochigi (JP); Hitoshi Otsuka, Tochigi (JP); Taichi Honma, Tochigi (JP)

Correspondence Address: BIRCH STEWART KOLASCH & BIRCH, PO BOX 747, FALLS CHURCH, VA, 22040-0747, US

(73) Assignee: Kao Corporation, Tokyo (JP)

(21) Appl. No.: 12/665,709

(22) PCT Filed: Jun. 20, 2008
(86) PCT No.: PCT/JP2008/061366

§ 371 Date: Feb. 24, 2010

(30) Foreign Application Priority Data
Jun. 21, 2007 (JP) 2007-163879

(51) Int. Cl. C08L 9/00; C08J 5/00; B29C 71/02

(52) U.S. Cl. 524/571; 264/319

(57) ABSTRACT

A shape memory rubber molded article (1) obtained from a mixture containing a rubber and a crystalline non-polymeric compound. The rubber in the molded article is crosslinked. A deformed state of the shape memory rubber molded article (1) is fixed by crystallizing the non-polymeric compound, and the fixed deformed state is released by melting the non-polymeric compound. The non-polymeric compound is preferably a wax. The shape memory rubber molded article (1) preferably contains a crosslinking agent. In the molded article (1), the rubber and the non-polymeric compound are preferably in finely divided separate phases.

### TECHNICAL FIELD

The present invention relates to a shape memory rubber molded article and a process and an intermediate composition for producing the same.

### BACKGROUND ART

In recent years various types of what we call shape memory resins having a high molecular weight and yet capable of restoring the original shape under a specific condition, e.g., of temperature have been proposed. Among them are elastomers and rubbers having shape memory properties disclosed in patent documents 1 and 2 (see below).

The technique of patent document 1 imparts shape memory properties to a non-thermoplastic elastomer having no shape memory by incorporating a resin having a higher glass transition temperature or melting temperature than the elastomer. The technique of patent document 2 imparts shape memory properties to a crosslinkable rubber by mixing and dispersing resin particles having a specific range of Vicat softening point in the rubber, followed by crosslinking.

In patent documents 1 and 2, the deformation ratio is low, the shape memory effect is small, the shape restoration rate is low, and the degree of restoration to an original shape is not sufficient. In addition, the freedom in setting the temperature for shape restoration from a fixed, deformed shape (hereinafter referred to as “release from fixed deformation”) is not high.

Apart from the above techniques, a thermally expandable material having a crosslinked rubber foam impregnated with a crystalline thermoplastic resin and a wax has been proposed. The thermally expandable material is obtained by compressing a foam impregnated with a crystalline thermoplastic resin and a wax using a hot press followed by cooling. The thermally expandable material has shape memory such that it maintains the compressed state at ambient temperature but, upon being heated, expands from its compressed state. The shape memory is achieved by making use of the phenomenon that, when the foam is compressed, the walls of individual cells adhere to each other via the thermoplastic resin to keep the compressed state. However, the thermally expandable material proposed has the following problems. (1) A deformed (compressed) state is not maintained unless the foam is deformed largely until the cell walls come into contact with each other. A shape memory effect would not develop with a small amount of deformation. (2) A good shape memory effect does not develop when the adhesion between the crosslinked rubber and the crystalline thermoplastic resin or the wax is weak. (3) Since the thermoplastic resin and wax are infiltrated into a previously shaped article of a crosslinked rubber foam, they can fail to uniformly and totally impregnate the article depending on the thickness or shape of the article, resulting in a failure to exhibit necessary shape memory. (4) When the amounts of the resin and wax in the cells are insufficient, the compressed foam poorly maintains the deformation. Conversely, when the amounts are too large, the foam poorly restores its original shape. Hence, the thermally expandable material cannot be seen as having sufficiently high shape memory due to the presence of a thermoplastic resin in the cells of a foam.

Patent document 1: JP 2004-10819A
Patent document 2: JP 9-309986A
Patent document 3: US 2004/0181003A1

### DISCLOSURE OF THE INVENTION

The present invention provides a shape memory rubber molded article obtained from a kneaded mixture containing a rubber and a crystalline non-polymeric compound. The rubber in the molded article is crosslinked. A deformed state of the shape memory rubber molded article is fixed by crystallization of the non-polymeric compound, and the fixed, deformed state is released by melting of the non-polymeric compound.

The invention also provides an intermediate kneaded composition for producing the shape memory rubber molded article. The intermediate kneaded composition contains a rubber and a crystalline non-polymeric compound. In the intermediate kneaded composition, the non-polymeric compound is in a crystallized state, the rubber and the non-polymeric compound are present in finely divided separate phases, and the rubber is uncrosslinked.

The invention also provides a shape memory rubber molded article obtained by kneading a rubber and a crystalline non-polymeric compound at a temperature lower than a melting completion temperature of the non-polymeric compound determined as follows to prepare an intermediate composition and then crosslinking the rubber. The melting completion temperature of the non-polymeric compound is determined by thermal analysis using a differential scanning calorimeter (DSC) in accordance with JIS K7121 to obtain a melting curve. The melting completion temperature corresponds to an intersection between a first tangent to a base line on the high temperature side of the melting peak and a second tangent to a slope of the melting curve located on the high temperature side of the melting curve. The second tangent is located at a point apart from that base line by ⅕ the height of the peak. When the melting curve has two or more peaks, the peak at the highest temperature is chosen to determine the melting completion temperature.

The invention also provides a process for producing a shape memory rubber molded article. The process includes the steps of kneading a rubber, a crystalline non-polymeric compound, and a crosslinking agent at a temperature lower than a melting completion temperature of the non-polymeric compound to prepare an intermediate kneaded composition, molding the intermediate kneaded composition, and crosslinking the rubber of the molded intermediate kneaded composition.

The invention also provides a process for producing a shape memory rubber molded article including the steps of kneading a rubber, a crystalline non-polymeric compound, and a crosslinking agent at a temperature lower than a melting completion temperature of the non-polymeric compound to prepare an intermediate kneaded composition, molding the intermediate kneaded composition, and crosslinking the rubber. The crosslinking is carried out simultaneously with or after the molding.

### BRIEF DESCRIPTION OF THE DRAWINGS

FIG. 1 is a schematic perspective of a shape memory rubber molded article of the invention.

FIG. 2 is a DSC curve showing the relationship between ΔH, ΔH′, and mixing temperature.

FIG. 3 is a DSC curve illustrating how to determine a melting completion temperature and a melting peak temperature.

FIG. 4 is a graph of tensile test results of a rubber molded article obtained in Example 1.

FIG. 5 is a melting curve of a wax used in Example 1.

FIG. 6 is a melting curve of a wax used in Example 5.

FIG. 7 is an image of an inner structure of the intermediate kneaded composition (before addition of a crosslinking agent and so on) prepared in Example 1, taken under a transmission electron microscope.

### DETAILED DESCRIPTION OF THE INVENTION

The invention relates to a shape memory rubber molded article and a process and an intermediate kneaded composition for producing the shape memory rubber molded article. The shape memory rubber molded article of the invention exhibits excellent shape memory in terms of, e.g., high deformation ratio, high speed of recovery, and small residual strain, enjoys a large freedom in setting a temperature for release from fixed deformation (providing a broad range of temperature for release even from a complicatedly deformed state), and is producible easily and conveniently.

The invention will be described with reference to its preferred embodiments.

The shape memory rubber molded article (hereinafter simply referred to as a rubber molded article) of the invention will be described first based on its preferred embodiment.

The rubber molded article of the present embodiment is formed of, and obtained form, a mixture of a rubber and a crystalline non-polymeric compound. The molded article has the rubber crosslinked. The rubber molded article is deformable at or above the melting temperature of the non-polymeric compound. The deformed state is fixed by crystallizing the non-polymeric compound. The fixed deformed state is released by heating the rubber molded article to or above the melting temperature of the non-polymeric compound. As used herein, the term “deform” includes, for example, pulling, bending, twisting, and a combination thereof.

The rubber molded article of the embodiment has the rubber and the non-polymeric compound finely divided into separate phases. When the rubber molded article has too high a proportion of the non-polymeric compound, not only is crosslinking of the rubber insufficient, but the amount of the rubber serving for strength will be insufficient to provide a molded article with strength (in terms of, e.g., breaking strength and modulus of elasticity), tending to result in a greater residual strain described infra. Conversely, when the proportion of the non-polymeric compound serving for shape memory is too small, the rubber molded article tends to reduce in elongation and shape retention. For all these considerations, the proportion of the non-polymeric compound in the total mass of the rubber and the non-polymeric compound is preferably 10% to 90% by mass, more preferably 20% to 80% by mass.

The rubber molded article of the embodiment has the rubber in a crosslinked state. The degree of crosslinking is decided according to the intended use of the rubber molded article. The degree of crosslinking may be decreased when an increased elongation or a reduced elastic modulus is demanded, or the degree of crosslinking may be increased when an increased breaking strength or an increased elastic modulus is desired. Whether or not the rubber is crosslinked or the degree of crosslinking is controllable by adjusting the amount of a crosslinking agent added or the intensity and amount of energy (e.g., heat, light, or electron beam) applied to induce crosslinking reaction and can be determined from the mechanical properties, such as elongation at break or modulus of elasticity, solvent solubility, NMR spectrum, and the like. The crosslinking may be effected not by covalent bonding but by physical crosslinking commonly employed for thermoplastic rubbers, such as styrene rubbers and olefin rubbers, which occurs through micros phase separation of crystalline or glassy domains.

The rubber that can be used in the rubber molded article of the present embodiment is not particularly limited and may be one or more selected from diene rubbers (rubbers containing double bonds in the main chain of the rubber component), such as natural rubber, styrene-butadiene rubber, butadiene rubber, chloroprene rubber, and nitrile rubber; and non-diene rubbers (rubbers having no double bonds in the main chain of the rubber component), such as butyl rubber, urethane rubber, silicone rubber, olefin rubber, styrene rubber, vinyl chloride rubber, urethane-based rubber, polyester rubber, and amide rubber. Diene rubbers that are easy to crosslink are preferred of them. Natural rubber, synthetic isoprene rubber, and butadiene rubber are especially preferred in terms of mixability with a non-polymeric compound. Synthetic rubber and butadiene rubber are preferred to natural rubber in view of odor, color, and proteins that can provoke an allergic response. According to the invention, a rubber molded article with unprecedentedly improved physical properties can be produced without using a solvent and the like by mixing a rubber, such as natural rubber, synthetic isoprene rubber, or butadiene rubber, with a non-polymeric compound. In particular, by mixing a non-polymeric compound and a rubber in accordance with the process of the present invention described infra, it is possible to mix the rubber and the non-polymeric compound microscopically uniformly. This brings about advantageous effects in greatly increasing the melt viscosity of the resulting rubber molded article or largely decreasing the brittleness of the rubber molded article at temperature below the melting temperature of the non-polymeric compound. Since the rubber molded article of the embodiment is obtained from a uniform mixed composition, it may be molded into any desired shape using general rubber or plastic molding techniques and crosslinked to yield articles of various forms and shapes.

FIG. 7 is an image of an inner structure of a mixture of polyisoprene (a rubber) and microcrystalline wax (a non-polymeric compound) in a mass ratio of 30:70 that was prepared by the process of the invention hereinafter described (the intermediate composition prepared in Example 1 given later, before the addition of a crosslinking agent, etc.), taken under a transmission electron microscope (TEM) H-7100FA, available from Hitachi, Ltd., at an accelerating voltage of 100 kV. A TEM specimen was prepared by slicing the mixture to make an ultrathin section and staining the section with OsO₄ and RuO₄. As is apparent from FIG. 7, the microcrystalline wax (non-polymeric compound) is in a crystallized state, and the polyisoprene (rubber) and the microcrystalline wax (non-polymeric compound) are in finely divided separate phases in the intermediate composition. In this state, the polyisoprene (rubber) is uncrosslinked. The size of the individual separate phases is preferably 50 μm or less, more preferably 30 μm or less, even more preferably 10 μm or less. In determining the size of the phases, a small dispersed phase of polyisoprene or microcrystalline wax is chosen to be measured for size. In the cases where the phase has an anisotropic shape, such as an elliptical or platy phase, its smallest dimension, such as a minor axis length or a shorter side length, is measured. It is seen from this TEM image that a very finely divided disperse state with a polyisoprene phase size of not more than 1 μm has been obtained. It is also seen that the microcrystalline wax phase has a lamellar crystal structure observed in crystals of waxes. Since the intermediate composition has such a finely dispersed structure, even when it is heated to or above the melting temperature of the non-polymeric compound and largely deformed, e.g., compressed or extended, separation of the non-polymeric compound from the rubber and resulting oozing of the molten non-polymeric compound will hardly occur. In this way, the rubber molded article of the present embodiment is able to stably retain shape memory properties and mechanical properties even when repeatedly subjected to heating, cooling, and deformation.

The rubber molded article preferably has a mass reduction of 10% or less, more preferably 5% or less, even more preferably 3% or less, by mass when the article is immersed in a liquid maintained at or above the melting temperature of the non-polymeric compound and in which the non-polymeric compound is insoluble. The mass reduction (mass %) is calculated according to formula below, where R is the ratio (mass %) of the non-polymeric compound to the total mass of the rubber and the non-polymeric compound.

$$Mass reduction = \frac{\begin{matrix}mass before immersion - \\ mass after immersion\end{matrix}}{mass before immersion \times \frac{R}{100}} \times 100$$

When the mass reduction of the rubber molded article falls within the preferred range recited, the rubber molded article may be deformed in, e.g., hot water and then dipped in cold water to set the deformed shape. In using a lipophilic non-polymeric compound, the liquid to be used is exemplified by water. In using a hydrophilic non-polymeric compound, the liquid is exemplified by an oil, such as paraffin oil. Whether a rubber molded article to have a mass reduction within the above recited preferred range is a measure of confidence about whether the rubber molded article possesses the above described preferred structure and performance. The temperature of the liquid is at or above the melting temperature of the non-polymeric compound and preferably not higher than the melting temperature by 30° or more. The immersion time in the liquid is 10 minutes.

In the case when a wax is infiltrated into the cells of a crosslinked rubber foam as proposed in patent document 3 supra, there is a problem, in addition to the problems (1) to (4), that the wax oozes out of the cells to stain the surroundings when the foam is deformed while the wax is in a molten state. If the amount of the impregnating resin or wax is reduced to avoid this problem, the inner walls of the cells do not achieve sufficient adhesion to each other, resulting in difficulty in stably holding the deformed shape. Moreover, since the technique described involves the steps of making a foam of crosslinked rubber and impregnating the foam with a resin and a wax, it has low process freedom and is costly.

The crystalline non-polymeric compound that can be used in the rubber molded article of the embodiment is a crystalline compound having a weight average molecular weight of less than 10000. As long as the weight average molecular weight is less than 10000, the compound has good compatibility with rubber, needs a short time for releasing the deformation, has a reduced residual strain, and therefore exhibits improved restoration to the original shape. The weight average molecular weight of the crystalline non-polymeric compound is preferably less than 5000, more preferably less than 1000. The lower limit of the weight average molecular weight is preferably 100, more preferably 200, for use in an ordinary environment because a non-polymeric compound with too small a weight average molecular weight has a low melting temperature. The term “crystalline” as used herein with respect to a non-polymeric compound means that the compound undergoes a reversible phase transition between liquid and solid phases: it crystallizes to a solid phase at or below the crystallization temperature and melts to a liquid phase at or above the melting temperature. The crystalline properties are confirmed by common techniques including structural analyses, such as X-ray diffractometry, and thermal analyses, such as differential scanning calorimetry.

In selecting the non-polymeric compound, it is preferred to select a non-polymeric compound that has good compatibility with a rubber to be used at or above the melting temperature of the no-polymeric compound. It is also preferred to take the following points (1) to (3) into consideration according to the purpose.
(1) It is preferred that the non-polymeric compound be melted into a low viscosity liquid. To have a low viscosity contributes to rapid release from fixed deformation.

An optimum melting temperature and an optimum melting rate are preferably selected as appropriate to the purpose because the fixed deformation is released upon the non-polymeric compound melting. With general utility taken into consideration, the melting temperature is preferably 40° to 300° C., more preferably 70° to 200° C. In the case when low-temperature release from fixed deformation is desired, it is possible to use a low melting wax, such as decane having a melting temperature of about −30° C. A non-polymeric compound exhibiting a sharp melting behavior with temperature change allows for rapid release from fixed deformation. On the other hand, a non-polymeric compound showing a broad melting behavior with temperature change allows for mild progress of the release from fixed deformation.
(2) Since the deformed state is fixed upon the non-polymeric compound crystallizing, it is preferred to select an optimum crystallizing temperature and an optimum crystallizing rate. In order to rapidly fix the deformed state, it is preferred for the non-polymeric compound to have a crystallizing temperature close to the melting temperature and to exhibit a sharp melting behavior.
(3) It is possible to use a plurality of non-polymeric compounds. When the non-polymeric compound system has a plurality of melting temperatures and crystallizing temperatures, the rubber molded article may be designed to show shape memory (e.g., release from fixed deformation) stepwise at different temperatures.

Examples of the non-polymeric compound include various crystalline aliphatic compounds and crystalline aromatic compounds. Preferred of them are waxes as having good compatibility with rubbers and providing a broad choice of melting temperature and melting temperature distribution.

Examples of the waxes include plant waxes, animal waxes, mineral waxes, petroleum waxes, and synthetic waxes. Examples of usable waxes are described, e.g., in Kenzo Fusegawa, Wax no seishitu-to-ohyo, 2nd Ed., Saiwai Shobo, 1993, 2, Table 1.0.1. The plant waxes include rice wax, carnauba wax, Japan wax, and candelilla wax. The animal waxes include bees wax, lanolin, and whale wax. The petroleum waxes include microcrystalline wax and paraffin wax. The synthetic waxes include polyethylene wax and Fisher-Tropsch wax. Examples of the mineral waxes are montan wax, ozokerite, and ceresin. Any of these waxes can be used preferably.

In view of use in an ordinary environment, a wax having a melting temperature of 40° C. or higher, preferably 60° C. or higher, as measured in accordance with JIS K2235-5.3.2 is suitable. It is particularly preferred to use a wax having a small low-melting component content for the following reason. In the case when a kneading machine having sufficient cooling ability is not available in the production of a rubber molded article according to the process described later, the low-melting component of the wax can melt by the shear heat generation during mixing to reduce the viscosity of the wax, resulting in a failure to exert a sufficient shear force to the components to be mixed together. For the same reason, it is preferred to use a wax having a small amorphous component content. There are some applications in which a rubber molding article is required to have some tackiness at ambient temperature (e.g., −10° to 40° C.). In such applications, it is preferred for the wax to contain an appropriate amount of a low-melting component or an amorphous component as long as the mixing operation is not affected.

The waxes described may be used either individually or as a combination of two or more thereof. When in using a rubber of biomass origin, such as natural rubber, and a wax of biomass origin, such as rice wax, carnauba wax, or a wax known as a derivative of fats and oils, there is obtained a shape memory material that reduces the greenhouse gas emission and has high environmental compatibility with biodegradability.

As used herein, the term “wax” is defined to be an organic substance having an alkyl group and being solid or semi-solid at room temperature according to Kenzo Fusegawa, ibid.

Obtained by mixing a rubber and a non-polymeric compound without using a solvent, the rubber molded article of the present embodiment is substantially free of a residual solvent. The concentration of the residual solvent is 3 ppm or less, which is below a detectable level. Thus, the production of an intermediate product or a final product using the rubber molded article of the invention is not harmful to working environment and is of high safety. The rubber molded article of the invention is safely made use of in various fields including packing materials for foods and the like.

The rubber molded article of the embodiment may contain a rubber crosslinking agent, a crosslinking aid for the crosslinking agent, and a crosslinking accelerator in addition to the rubber and the non-polymeric compound.

The crosslinking agent may be selected from those conventionally employed for rubbers as appropriate to the rubber used. Examples of useful crosslinking agents include sulfur, sulfur monochloride, selenium, tellurium, zinc oxide, magnesium oxide, thiurams, such as thiuram disulfride, dithiocarbamates, such as zinc dithiocarbamate, oximes, such as p-quinone dioxime, dinitroso compounds, such as tetrachloro-p-benzoquinone and poly-p-dinitrobenzene, and organic peroxides, such as peroxides. Sulfur, a sulfur compound, and an organic peroxide are preferred crosslinking agents for natural rubber, synthetic isoprene rubber, and butadiene rubber. These crosslinking agents may be used either alone or in combination of two or more thereof. The crosslinking agent is preferably used in an amount of 0.5 to 30 parts, more preferably 2 to 10 parts, by mass per 100 parts by mass of the rubber. If the amount of the crosslinking agent is too small, the crosslinking reaction is apt to be nonuniform. Use of too large an amount of the crosslinking agent is liable to damage the elastic properties of the rubber.

The crosslinking accelerator and the crosslinking acceleration aid may be selected from those conventionally employed for rubbers. Examples of the crosslinking accelerator include thioazoles, sulfonamides, thiurams, and dithiocarbamates. Examples of the crosslinking acceleration aids include metal oxides, fatty acids, and amines. The crosslinking accelerators and the crosslinking acceleration aids may be used either individually or in combination of two or more thereof. The amount of the crosslinking accelerator and the crosslinking acceleration aid is preferably chosen from a range commonly used in rubber crosslinking. The amount is preferably 0.05 to 10 parts, more preferably 0.1 to 7 parts, by mass per 100 parts by mass of the rubber.

The rubber crosslinking may be performed without the aid of a crosslinking agent but by applying crosslink-inducing energy other than heat, such as an electron beam or light.

If desired, the rubber molded article of the embodiment may contain various additives generally and conventionally used in a rubber composition in a range that does not affect the effects of the rubber molded article or the production process of the article, such as colorants, antioxidants, general-purpose reinforcing agents or fillers, various kinds of oil, and plasticizers. Where the crystalline thermoplastic resin described in patent document 3 supra is not a component serving as a rubber in the rubber molded article or the intermediate composition of the embodiment, it is preferred that the rubber molded article of the embodiment be free from the crystalline thermoplastic resin.

The rubber molded article of the embodiment may have any form like common rubber molded articles. It is provided in one-dimensional forms, such as rods and fibers; two-dimensional forms, such as sheets, nonwoven fabrics, and woven fabrics; or three-dimensional forms, such as tubes, either hollow (as illustrated in FIG. 1) or solid, cubes, and spheres. The size of the rubber molded article may broadly range, for example, from particles of 1 mm or smaller, sheets of continuous length with a width exceeding 1 m, to large-sized, three-dimensional parts used in, e.g., automobiles and airplanes.

The rubber molded article of the invention exhibits rubber elasticity at temperatures lower than the melting temperature and at or above the melting temperature of the non-polymeric compound. Since the non-polymeric compound becomes liquid at or above its melting temperature, the rubber molded article usually has a lower elastic modulus at or above the melting temperature than below the melting temperature of the non-polymeric compound. It is possible to increase or decrease the difference in elastic modulus of the rubber molded article between at or above the melting temperature and below the melting temperature of the non-polymeric compound by the selection of the kind or the amount of the non-polymeric compound. Hence, the rubber molded article of the invention may be designed not only as a shape memory article but also as an elastic article that largely changes in elastic modulus between at or above and below the melting temperature of the non-polymeric compound. For example, it is feasible to make a rubber molded article having a ratio of E_{L}, the elastic modulus below the melting temperature of the non-polymeric compound, to E_{H}, the elastic modulus at or above the melting temperature of the non-polymeric compound, (E_{L}/E_{H}) of 5 or more, or even greater, i.e., 10 or more. It is also possible for the rubber molded article to exhibit rubber elasticity even after having been deformed by heating to or above the melting temperature of the non-polymeric compound and fixed at the deformed state by cooling. When a rectangular specimen of such a rubber molded article is stretched twice in one direction, and the deformation is fixed, it is preferred for the deformed specimen to still have deformability of at least 10%, more preferably 20% or more, in the same direction (maximum deformation ratio before break) at room temperature. In that test, the residual strain is preferably 10% or less, more preferably 5% or less. The residual strain may sometimes be negative since the specimen has been held in a monoaxially stretched state.

When the rubber molded article of the embodiment is heated at or above the melting temperature of the non-polymeric compound to melt the non-polymeric compound, deformed in the heated condition, and then cooled in a deformed state to fix the deformation, the deformation ratio of the rubber molded article may be decided arbitrarily. The deformation ratio is preferably 1.1 to 10, more preferably 1.5 to 5, in at least one direction.

As stated, the rubber molded article of the embodiment is, after being deformed, fixed in the deformed state by cooling below the melting temperature of the non-polymeric compound to crystallize the non-polymeric compound. To release the fixed deformation, the non-polymeric compound is melted.

The residual strain after the release from the fixed deformation may be controlled by the degree of crosslinking and the like. In general, the residual strain is preferably as small as possible, although there are cases in which a large residual strain is desirable in some applications. The larger the amount of deformation is and the larger the number of times of deformation is, the larger the permanent strain tends to be. When the rubber molded article is maintained in a monoaxially three or more times stretched state and then released from the fixed deformation, the residual strain is preferably 30% or less, more preferably 20% or less, even more preferably 10% or less. A residual strain ε (unit: %) is calculated according to formula:

ε=((L−L₀)/L₀)×100

wherein L₀ is the initial length of a specimen; and L is the length after release from fixed deformation.

The process for producing the rubber molded article of the invention will then be described based on an embodiment in which the process is applied to the production of the rubber molded article of the foregoing embodiment.

The process for producing a rubber molded article of the present embodiment includes mixing a rubber, a crystalline non-polymeric compound, and a crosslinking agent at a temperature lower than the melting completion temperature of the non-polymeric compound to prepare an intermediate kneaded composition, molding the intermediate kneaded composition, and crosslinking the rubber.

In the case where a crosslinking acceleration aid or a crosslinking accelerator is added as described previously, it is preferably mixed with the rubber, non-polymeric compound, and crosslinking agent at a temperature lower than the melting completion temperature and lower than the crosslinking temperature of the crosslinking agent. According to this process, mixing is carried out uniformly at a low temperature so that the crosslinking agent and additives, such as a crosslinking acceleration aid and a crosslinking accelerator, are well dispersed without inducing crosslinking reaction. In this regard, the process is very industrially beneficial. To ensure preventing the additives from deteriorating and a crosslinking reaction from occurring by the heat generated during mixing, it is preferred that the rubber and the non-polymeric compound have previously been mixed to or above a certain degree prior to the addition of the crosslinking agent and so on.

In carrying out the process of producing the rubber molded article of the embodiment, it is preferred that the components described be mixed in the compounding ratio described at a temperature lower than the melting completion temperature of the non-polymeric compound, preferably at or below the melting peak temperature determined from an melting curve obtained by DSC analysis, by a mechanical force of various mixing or kneading machines. When the melting curve has two or more melting peaks, the mixing is preferably conducted at or below the peak temperature of the peak having the greatest endothermic energy. If the non-polymeric compound is mixed with the other components at or above the melting temperature of the non-polymeric compound, the non-polymeric compound steeply reduces in viscosity because of its melting and fails to transmit sufficient shear force to the components. As a result, mixing would be insufficient, which can make it difficult to provide a uniform composition. As long as the mixing temperature is lower than the melting completion temperature of the non-polymeric compound, there remain unmelted crystals of the non-polymeric compound in the system, whereby the non-polymeric compound behaves seemingly as a high-viscosity fluid. As a result, mixing is carried out in a manner commonly practiced in preparing a plastic compound. The lower limit of the mixing temperature is preferably the lowest temperature at which the rubber exhibits fluidity, which corresponds to a glass transition temperature or, in the case of a thermoplastic rubber, a melting temperature of the rubber. The mixing temperature is more preferably at or above the melting onset temperature (Ts) of the non-polymeric compound. To make a highly versatile rubber molded article, a non-polymeric compound having a melting temperature higher than the normal environmental room temperature is selected for preference. In that case, the melting temperature of the selected non-polymeric compound is preferably 20° C., more preferably 50° C. DSC, differential scanning calorimeter, is an instrument for determining exothermic and endothermic energies of a sample through raising or dropping the sample temperature at a constant rate. The method of determining transition temperatures using DSC is specified in JIS K7121, and the method of determining heat of transition is specified in JIS K7122.

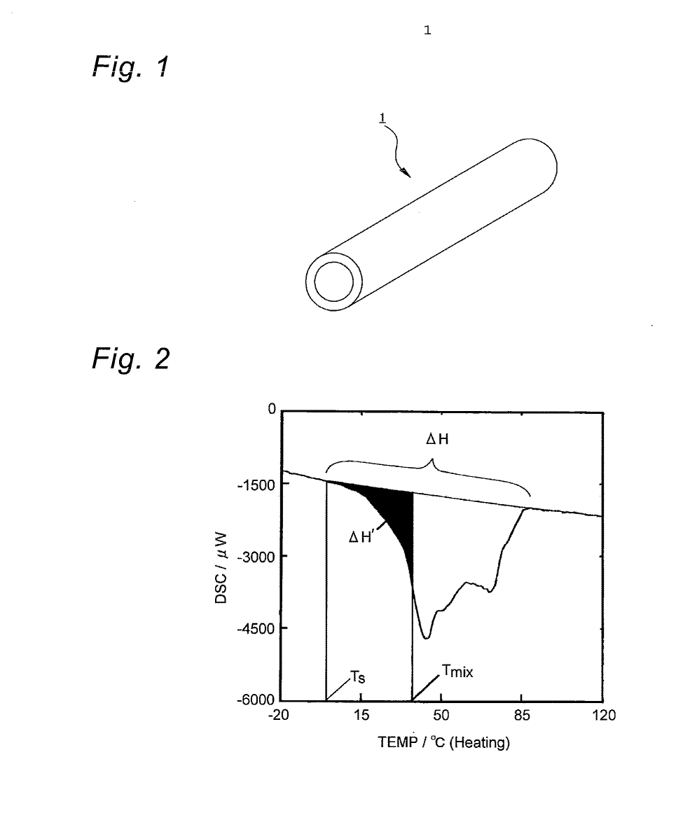

A still preferred mixing temperature is determined as follows. FIG. 2 showing a melting curve of a non-polymeric compound obtained by DSC analysis is referred to. The total endothermic energy of the melting non-polymeric compound is taken as ΔH. Mixing is carried out satisfactorily in a temperature range in which the integrated endothermic energy ΔH′ in the lower temperature side (from the melting onset temperature Ts up to a mixing temperature Tmix) is preferably 70% or less, more preferably 50% or less, even more preferably 30% or less, of ΔH. Mixing at lower temperatures than the melting onset temperature of the non-polymeric compound is not problematic. Nevertheless, when it is desirable for a non-polymeric compound, particularly, a highly crystalline, hard compound to have body, the lower limit of the mixing temperature is preferably set so that the integrated value ΔH′ may be at least 3%, more preferably 5% or more, of the ΔH.

The optimal mixing temperature is appropriately selected from the above-mentioned temperature range in accordance with the physical properties of the components to be mixed up. It is preferred that the mixing temperature be adjusted within the above-recited preferred range so that both the rubber and the non-polymeric compound may be in their most suitable physical conditions for mixing, with due considerations given to the temperature dependence of the physical properties of the non-polymeric compound and other components.

The melting completion temperature, the melting peak temperature, and the ΔH′ to ΔH ratio of the non-polymeric compound used in the present embodiment are determined, for example, as follows.

### Instrument:

DSC 220 from Seiko Instruments, Inc.

### Sample Container:

PN/50-020 (15 μl-volume, aluminum-made open pan) and PN/50-021 (aluminum-made lid for crimping)

### Sample Mass:

about 10 mg

### Rate of Temperature Rise and Fall:

5° C./min

### Atmosphere:

Nitrogen gas flow

### Measuring Temperature Range:

An optimal temperature range is set depending on the non-polymeric compound to be analyzed. A sample is once melted, cooled at a rate of 5° C./min to crystallize, and re-heated at a rate of 5° C./min. The data recorded during the re-heating are used to obtain the melting completion temperature and the melting peak temperature.

For example, a sample is subjected to a first temperature rise of from 30° C. to 130° C., maintained at 130° C. for 5 minutes, cooled from 130° C. to −30°, and subjected to a second temperature rise of from 30° C. up to 130° C. Meanwhile, the data are continuously recorded, and the data during the second temperature rise are made use of.

### Melting Completion Temperature:

The non-polymeric compound is analyzed using DSC in accordance with JIS K7121 to obtain a melting curve. As illustrated in FIG. 3, the melting completion temperature is a temperature at the intersection between a first tangent L1 to the base line on the high temperature side of the melting peak and a second tangent L2 to a slope of the melting curve located on the high temperature side of the melting curve. The second tangent is located at a point apart from that base line by ⅕ the height of the peak. When the melting curve has two or more peaks, the peak at the highest temperature is chosen to determine the melting completion temperature.

### Main Peak Temperature:

The peak temperature of the melting curve is read from the above-specified data. When there are two or more peaks, the peak showing the greatest endothermic energy is chosen to obtain the peak temperature.

Since the components are mixed while the non-polymeric compound is partially in its crystalline state, it is preferred to use a mixing apparatus for kneading a high-viscosity material. Since it is necessary to control the mixing temperature to an optimum temperature lower than the melting completion temperature of the non-polymeric compound in order to obtain a uniformly mixed state, a mixing apparatus of which the mixing chamber is controllable at a low temperature is preferred. The mixing apparatus is preferably designed to cool its moving parts, such as a rotor or a screw, as well. From these considerations, mixing is preferably carried out by use of a pressure kneader, an open kneader or a roll kneader.

The above described operation provides an intermediate composition as a precursor of a rubber molded article. The intermediate composition contains the rubber in its uncrosslinked state. The intermediate composition can contain air bubbles entrained during the step of mixing. Where needed, the composition is subjected to deaeration by a usual method. For example, deaeration is performed by maintaining the composition in a constant temperature chamber under reduced pressure at or above the melting temperature of the non-polymeric compound and below the crosslinking onset temperature of the rubber or by kneading the composition at or above the melting temperature of the non-polymeric compound and below the crosslinking onset temperature of the rubber under reduced pressure in a mixing apparatus, e.g., a kneader, equipped with an evacuation means.

The intermediate composition is heated at or above the melting temperature of the non-polymeric compound and at or above the crosslinking temperature of the rubber to crosslink the rubber whereby a desired rubber molded article is obtained. The crosslinking of the rubber may be effected either in an independent step after molding the intermediate composition or simultaneously with the step of molding the intermediate composition. In the latter case, change in shape during crosslinking is prevented by, for example, molding the intermediate composition by injection molding or press forming using a heated mold. After completion of the molding, the molded product is subjected, where necessary, to a finishing operation, such as trimming, to complete the production of a rubber molded article.

In the cases where a rubber that is to be crosslinked by means of a crosslinking agent, an electron beam, an electromagnetic wave, and the like is used, it is preferred that the crosslinking of the rubber be preceded by the molding of the intermediate composition. The molding method is chosen as appropriate to the kind of the raw materials (i.e., the rubber, the crystalline non-polymeric compound, and so on), the properties of the intermediate composition, the dimension, form or production scale of the molded article, and the like. Any molding method commonly used for rubbers and plastics may be used. Preferred molding methods include extrusion molding (for the production of films, sheets, rods, pipes, etc.), injection molding (for the production of blocks, rods, pipes, etc.), press forming (for the production of films, sheets, blocks, etc.), cast molding (for the production of blocks, rods, pipes, etc.), and blow molding (for the production of hollow molded articles). A rubber molded article obtained by these molding methods may be machined (e.g., cutting or punching) into a desired shape. The molded articles thus obtained may be laminated or combined with each other, or the molded article thus obtained may be laminated or combined with an otherwise molded article.

According to the process of the present embodiment, a rubber molded article exhibiting high shape memory properties and providing high freedom in setting the temperature for release from fixed deformation is produced easily and conveniently.

The application of the rubber molded article of the invention is unlimited. In particular, the rubber molded article produced by the aforementioned process, being free from an organic solvent, can be used with very high safety in a variety of fields. The rubber molded article of the invention may be produced by other processes, for example, (a) a process in which a rubber is mixed into a molten non-polymeric compound or (b) a process in which a rubber and a non-polymeric compound are dissolved in a solvent and mixed. Nevertheless, the process (a) involves environmental and economical disadvantages because of large energy consumption for heating and need of longer time for mixing. The process (b) is associated with the problem that the solvent can remain in the product or be emitted into the environment and an economical disadvantage due to large energy consumption for drying but is effective in producing particulate molded article.

The rubber molded article of the invention is useful as, for example, a shrink tube that is deformed to have an increased inner diameter and releasable from the deformation; a shape transfer sheet that is used to memorize and transfer the three-dimensional shape of an object; or a jig for holding an object of varied shape, such as a jig used in an apparatus for filling packing containers with a liquid product, the jig being used to hold a container and deformable in conformity to a change of the contour of a container. The rubber molded article is also used as an article able to fitting the contour of a human or animal body part, such as clothing (including headgear, shoes, such as sport shoes, e.g., ski boots), seats of vehicles (including automobiles and airplanes), personal articles (including masks, glasses, goggles, helmets, mouse pads, and pillows), beds, medical appliances (such as casts and prostheses), protective guards or gears for sports (e.g., racket grips), stationery, and handles of tableware and cookware (e.g., spoons), and the like. It also finds use taking advantage of good response to temperature as a switching material that shrinks at a specific temperature (i.e., the melting temperature of the non-polymeric compound) or a part assembled into a machine that shrinks to hold an object or releases the hold at a specific temperature. The intermediate mixture may be converted to a fibrous rubber molded article which will find applications other than described above, such as containers deformable in conformity to particular purposes, materials filling gaps or scratches of buildings or furniture, housings of home electric appliances deformable to particular purposes, interior fittings and accessories of automobiles, and hair styling implements (e.g., hair brushes and permanent waving tools).

### EXAMPLES

The present invention will now be illustrated in greater detail with reference to Examples, but it should be understood that the invention is not limited thereto.

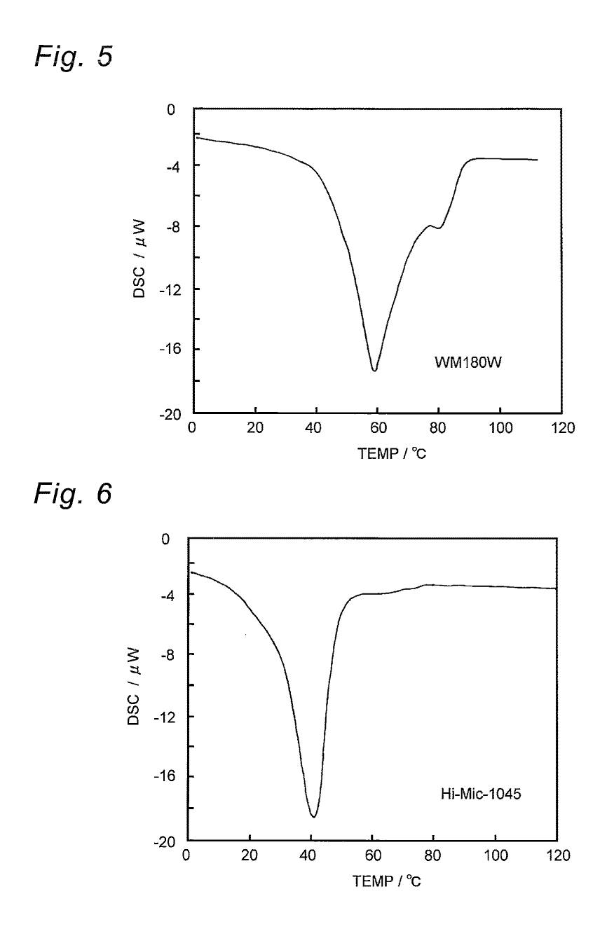

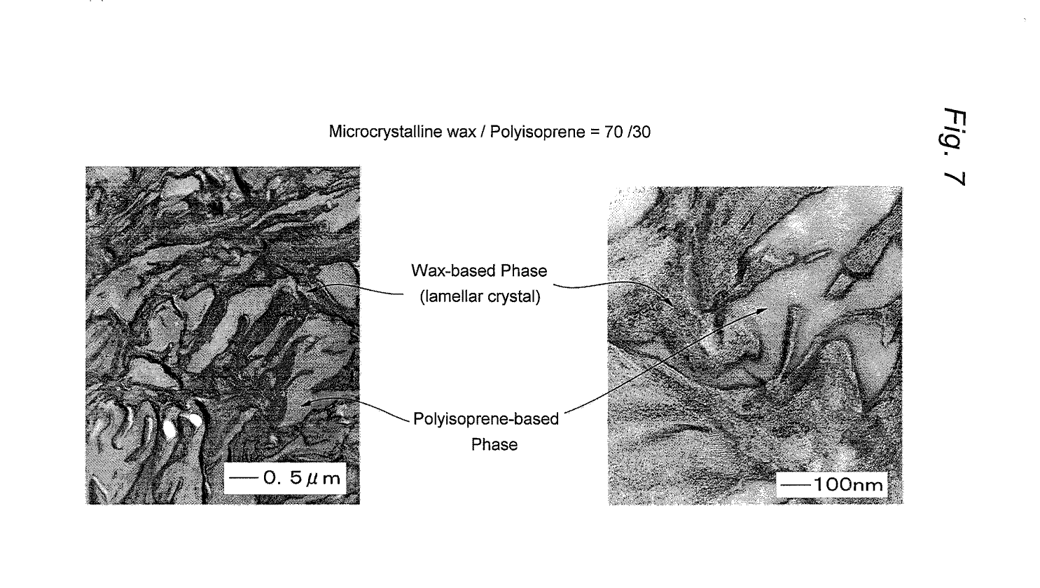

Rubber molded articles were made using the components shown in Table 1 in the compounding ratio shown in Table 2 in accordance with the procedures described in Examples 1 and 2. The rubber elasticity and shape memory of the resulting rubber molded articles were evaluated as follows. The melting curve of wax (1) and wax (2) described in Table 1 are shown in FIGS. 5 and 6, respectively.

TABLE 1

| | |
|---|---|
| Component | Product Number, Supplier, Physical Properties, etc. |
| Rubber | synthetic isoprene rubber (IR2200, Zeon Corp.) |
| Wax | (1) microcrystalline wax (WM180W, Toyo Petrolite Co., Ltd.); melting |
| | completion temp.: 80° C.; melting peak temp.: 59° C.; total endothermic |
| | energy until melting ΔH: 204 J/g |
| | (2) microcrystalline wax (Hi-Mic-1045, Nippon Seiro Co., Ltd.); melting |
| | completion temp.: 78° C.; main peak temp.: 44° C.; total endothermic energy |
| | until melting ΔH: 130 J/g |
| Crosslinking | sulfur |
| Agent | |
| Crosslinking | (A) zinc oxide |
| Acceleration Aid | (B) stearic acid |
| Crosslinking | (A) 2-mercaptobenzothiazole (Accel DM-R, Kawaguchi Chemical Industry |
| Accelerator | Co., Ltd.) |
| | (B) tetramethylthiuram disulfide |

TABLE 2

| | Composition (parts by mass) | | | | |
|---|---|---|---|---|---|
| | Example 1 | Example 2 | Example 3 | Example 4 | Example 5 |
| Rubber | 30 | 30 | 50 | 70 | 30 |
| Wax | (1) 70 | (2) 70 | (1) 50 | (1) 30 | (2) 70 |
| Crosslinking | 2.25 | 2.25 | 2.25 | 2.25 | 2.25 |
| Agent* | | | | | |
| Crosslinking | (A) 5 (B) 2 | (A) 5 (B) 2 | (A) 5 (B) 2 | (A) 5 (B) 2 | (A) 5 (B) 2 |
| Acceleration Aid* | | | | | |
| Crosslinking | (A) 1 | (B) 1 | (A) 1 | (A) 1 | (A) 1 |
| Accelerator* | | | | | |
| Mixing Temp. (° C.) | 52 | 52 | 55 | 60 | 32 |
| ΔH′/ΔH (%) at | 19 | 19 | 29 | 49 | 24 |
| Mixing Temp. | | | | | |

*The compounding ratio is based on the total mass of rubber and non-polymeric compound.

### Example 1

A jacketed pressure kneader (DS0.3-3, from Moriyama Manufacturing Co., Ltd.) was used. Into the mixing chamber of the pressure kneader were put the rubber and wax of Table 1 and kneaded at 52° C. (the temperature of the mixture immediately after completion of kneading), which was lower than the melting completion temperature of the wax, while passing cooling water at 13° C. through the jacket. The crosslinking agent, crosslinking acceleration aid, and crosslinking accelerator shown in Table 1 were then added to the mixture, followed by further kneading at the same temperature for 5 minutes. The resulting mixture was put into a tray covered with silicone release film and deaerated in a nitrogen gas flow at 100° C. and under reduced pressure of 600 hPa for 24 hours to prepare an intermediate composition. The intermediate composition was pressed into a 1 mm thick sheet in a press set at 120° C. and maintained at that temperature for 300 minutes to crosslink the rubber to produce a rubber molded article.

### Example 2

A rubber molded article was produced in the same manner as in Example 1, except for changing the crosslinking accelerator as shown in Table 2 and changing the temperature of the press to 140° C. and the crosslinking time to 30 minutes.

### Examples 3 and 4

Rubber molded articles were produced in the same manner as in Example 1, except for changing the compounding ratio of the rubber and wax as shown in Table 2.

### Example 5

A rubber molded article was produced in the same manner as in Example 1, except for changing the wax as shown in Table 1.

### Method of Evaluating Rubber Elasticity

The resulting rubber molded articles were evaluated as follows. A 5 mm wide and 50 mm long rectangular specimen was cut out of each rubber molded article and marked with two gauges spaced 30 mm apart at the middle thereof. The specimen was 50% extended (i.e., until the distance between two gauges increased to 45 mm) in each of air at room temperature (20° C.) and hot water at 95° C. to evaluate extensibility. The stress was removed, and the residual strain was determined. Because rubber elasticity required varies according to use, extensibility less than 50% does not mean that the article is out of the scope of the invention. The residual strain was obtained from formula: ((d−30)/30)×100(%), where d is the distance between gauges after stress removal.

### Method of Evaluating Shape Memory

A 5 mm wide and 50 mm long rectangular specimen was cut out of the rubber molded article and marked with two gauges spaced 30 mm apart at the middle thereof. The specimen was extended in hot water at 100° C. to increase the distance between two gauges to 60 mm, maintained in that elongated state in water at 20° C., and then put into hot water at 95° C. to release the fixed deformation, and the residual strain was determined. In Example 1, this operation was repeated four times to examine the shape memory effect in repeated deformation. The results obtained are shown in Table 3.

### Results of Evaluation of Rubber Elasticity in Example 1

The specimen was 50% extensible both at room temperature and in water at 95° C. at which the non-polymeric compound completely melted. The residual strain after release from the extended state was 2% at room temperature and 1% in 95° C. water, proving to have physical properties of a rubber.

The specimen was also proved to exhibit shape memory in repeated deformation with a small residual strain (see Table 3).

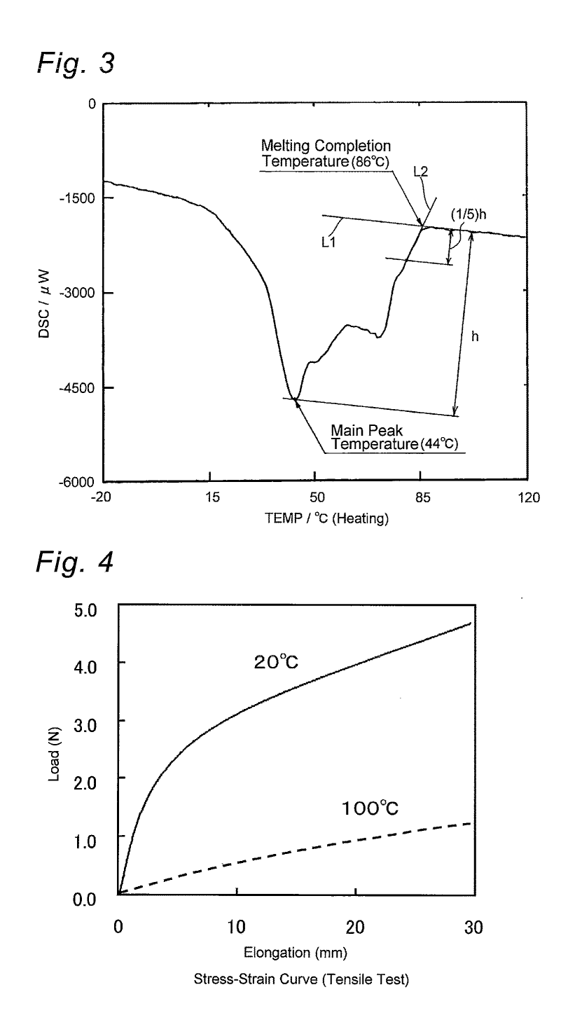

The rubber molded article was additionally evaluated according to the following methods.
(1) The marked specimen was held in a more highly extended state with the distance between gauges being 115 mm (extension ratio: 3.8) and then released from the fixed deformation in hot water at 95° C. in the same manner as above. The distance between gauges returned to 35 mm (residual strain: 17%), indicating shape memory effect and high recovery even at a higher deformation ratio.
(2) A 5 mm wide and 100 mm long rectangular specimen was cut out of the rubber molded article and marked with two gauges spaced 50 mm apart at the middle thereof. The specimen was extended until the distance between two gauges became 100 mm in hot water at 100° C. and fixed in that deformed state in water at 20° C. When the extended specimen was again marked with gauges 50 mm spaced apart and further extended twice at room temperature, the residual strain was 0%. This demonstrates that the molded article functions as an elastic body even after it is held in a deformed state.
(3) A 5 mm wide specimen (thickness: 1 mm) cut out of the rubber molded article was set on a tensile tester (Tensilon universal tester RTA500, from Orientec Co., Ltd.) equipped with a low/high constant temperature chamber (TCF-R3T-A, from Yashima Seisakusho) with an initial jaw separation of 30 mm. When pulled at a rate of 100 mm/min at 20° C. and 100° C., the specimen had a tensile elastic modulus of 1.35 Mpa and 0.086 Mpa, respectively, giving a ratio of 15.7, which indicates that the elastic modulus largely change around the melting temperature. The stress-strain curve up to a strain of 200% is shown in FIG. 4. As is shown in FIG. 4, since the elastic modulus abruptly changes at a certain temperature, shock absorption or repulsion properties as well as stiffness largely change at that temperature. It is thus seen that the rubber molded article and the intermediate composition of the invention are usable as a temperature-sensitive rubber that largely changes in physical properties, such as stiffness, shock absorption properties, and shock repulsion properties, in a desired temperature range.

### Results of Evaluation of Rubber Elasticity in Example 2

As a result of evaluation of rubber elasticity, the specimen was 50% extensible both at room temperature and in water at 95° C. The residual strain after release from the extended state was 6% at room temperature and 2% in 95° C. water. The specimen was also proved to exhibit shape memory in repeated deformation with a small residual strain (see Table 3).

TABLE 3

| Residual Strain | Example 1 | Example 2 |
|---|---|---|
| 1st Time | 5% (length after recovery: 31.5 mm) | 17% (length after |
| | | recovery: 35 mm) |
| 2nd Time | 10% (length after recovery: 33 mm) | — |
| 3rd Time | 10% (length after recovery: 33 mm) | — |
| 4th Time | 10% (length after recovery: 33 mm) | — |

### Results of Evaluation of Shape Memory and Residual Strain in Examples 1 and 3 to 5

The rubber molded articles obtained in Examples 1 and 3 to 5 were evaluated in terms of shape memory in repeated deformation and residual strain in accordance with the following procedure. The results are shown in Table 4. The specimen of Example 1 was prepared separately from those used in the above described testing.
(a) Cut a 5 mm wide and 50 mm long rectangular specimen out of each rubber molded article and mark it with two gauges 30 mm spaced apart in the middle thereof.
(b) Extend the specimen in hot water at 95° to 100° C. to increase the distance between gauges to 60 mm.
(c) Put the specimen as extended in water at 20° C. to fix the deformation.
(d) Take the specimen out of water and place it on a table. Measure the distance d1 between gauges. Calculate the percent shrinkage from [(60−d1)/60]×100.
(e) Put the specimen again in hot water at 95° to 100° C. to release it from the fixed deformation.
(f) Put the specimen released from the deformation in water at 20° C. to set the released state.
(g) Take the specimen out of water and place it on a table. Measure the distance d2 between gauges. Calculate the residual strain from [(d2−30)/30]×100.
(h) Repeat the operations (b) through (g) three times.

In Table 4, the distances shown in the rows entitled “shrinkage” are distances d1, and those in the rows entitled “residual strain” are distances d2.

### Results of Evaluation of Elongation at Break (Breaking Elongation) in Examples 1 and 3 to 5

The rubber molded articles obtained in Examples 1 and 3 to 5 were subjected to tensile test to determine breaking elongation. The results obtained are shown in Table 5. All the samples were proved to have a high breaking elongation. The testing conditions are shown below. The breaking elongation is defined to be [(L−25)/25]×100(%), where L is the distance between jaws measured at the moment of rupture. The specimen of Example 1 was prepared separately from those used in the above described evaluations.

Specimen dimension: 10 mm (w)×75 mm (l)×1.5 to 2.0 mm (t)
Initial separation between jaws: 25 mm
Pulling rate: 100 mm/min

### Environment: 23° C., 50% RH

TABLE 4

| | | 1st Time | 2nd Time | 3rd Time | 4th Time |
|---|---|---|---|---|---|
| Example 1 | Shrinkage | 3% | 3% | 4% | 4% |
| | | (length: 58.0 mm) | (length: 58.0 mm) | (length: 57.5 mm) | (length: 57.5 mm) |
| | Residual | 2% | 2% | 2% | 2% |
| | Strain | (length: 30.5 mm) | (length: 30.5 mm) | (length: 30.5 mm) | (length: 30.5 mm) |
| Example 3 | Shrinkage | 10% | 12% | 10% | 10% |
| | | (length: 54.0 mm) | (length: 53.0 mm) | (length: 54.0 mm) | (length: 54.0 mm) |
| | Residual | 3% | 3% | 3% | 3% |
| | Strain | (length: 31.0 mm) | (length: 31.0 mm) | (length: 31.0 mm) | (length: 31.0 mm) |
| Example 4 | Shrinkage | 28% | 28% | 28% | 28% |
| | | (length: 43.0 mm) | (length: 43.0 mm) | (length: 43.0 mm) | (length: 43.0 mm) |
| | Residual | 2% | 3% | 3% | 3% |
| | Strain | (length: 30.5 mm) | (length: 31.0 mm) | (length: 31.0 mm) | (length: 31.0 mm) |
| Example 5 | Shrinkage | 8% | 7% | 7% | 7% |
| | | (length: 55.0 mm) | (length: 56.0 mm) | (length: 56.0 mm) | (length: 56.0 mm) |
| | Residual | 2% | 2% | 2% | 2% |
| | Strain | (length: 30.5 mm) | (length: 30.5 mm) | (length: 30.5 mm) | (length: 30.5 mm) |

TABLE 5

| | Breaking Elongation (%) |
|---|---|
| Example 1 | 2642 |
| Example 3 | 3094 |
| Example 4 | 3767 |
| Example 5 | 2243 |

It is seen from the above results that all the rubber molded articles tested have rubber elasticity. It is also seen from Table 3 that all the rubber molded articles tested exhibit shape memory.

Results of Evaluation of Recovery from Shrinkage in Examples 1 and 4

The following test was carried out to confirm that the shrinking temperature of the rubber molded articles is controllable by making use of the difference in melting temperature of the wax. The results obtained are shown in Table 6.
(a) Cut a 5 mm wide and 50 mm long rectangular specimen out of each rubber molded article and mark it with two gauges 30 mm spaced apart in the middle thereof.
(b) Extend the specimen in hot water at 95° to 100° C. to increase the distance between gauges to 60 mm.
(c) Put the specimen as extended in water at 20° C. to fix the deformation.
(d) Take the specimen out of water and place it on a table. Measure the distance d3 between gauges. Calculate the percent shrinkage A from [(60−d3)/60]×100.
(e) Put the specimen in water at 40° C.
(f) Take the specimen out of 40° C. water and put it in water at 20° C. to set the shape.
(g) Take the specimen out of water and place it on a table. Measure the distance d4 between two gauges to obtain the percent shrinkage B from [(60−d4)/60]×100.
(h) Put the specimen again in hot water at 95° to 100° C. to release it from the fixed deformation.
(i) Put the specimen released from the fixed deformation in water at 20° C. to set the shape.
(j) Take the specimen out of water and place it on a table. Measure the distance d5 between gauges, which is the restored length. Calculate the residual strain from [(30−d5)/30]×100.
(k) Repeat the operations (b) through (j) three times.

In Table 6, the distances shown in the rows entitled “shrinkage” are distances d3 or d4, and those in the rows entitled “residual strain” are distances d5.

TABLE 6

| | | 1st Time | 2nd Time | 3rd Time | 4th Time |
|---|---|---|---|---|---|
| Example 1 | Shrinkage A | 8% | 10% | 10% | 10% |
| | (@100° C.) | (length: 55.0 mm) | (length: 54.0 mm) | (length: 54.0 mm | (length: 54.0 mm |
| | Shrinkage B | 9% | 11% | 11% | 11% |
| | (@40° C.) | (length: 50.0 mm) | (length: 48.0 mm) | (length: 48.0 mm) | (length: 48.0 mm) |
| | Residual | 3% | 3% | 3% | 3% |
| | Strain | (length: 31.0 mm) | (length: 31.0 mm) | (length: 31.0 mm) | (length: 31.0 mm) |
| Example 4 | Shrinkage A | 0% | 0% | 2% | 2% |
| | (@100° C.) | (length: 60.0 mm) | (length: 60.0 mm) | (length: 59.0 mm) | (length: 59.0 mm) |
| | Shrinkage B | 40% | 40% | 38% | 38% |
| | (@40° C.) | (length: 36.0 mm) | (length: 36.0 mm) | (length: 37.2 mm) | (length: 37.2 mm) |
| | Residual | 3% | 3% | 3% | 3% |
| | Strain | (31.0 mm) | (31.0 mm) | (31.0 mm) | (31.0 mm) |

As is apparent from the results in Table 6, the rubber molded article containing a wax with a lower melting temperature (Example 4) recovers to a higher degree when released from fixed deformation. It is thus seen that the degree of recovery from fixed deformation at a desired temperature is controllable by selecting the melting temperature of the wax to be compounded into a rubber molded article.

### Results of Determination of Mass Reduction in Examples 2 to 5

The mass reduction of the rubber molded article due to immersion in a liquid was determined by the following procedure. The results obtained are shown in Table 7.
(a) Prepare a 30 mm wide, 30 mm long, and 2 to 4 mm thick rubber molded article as a specimen or cut a specimen of that size out of a previously prepared rubber molded article. Measure the mass of the specimen.
(b) Immerse the specimen in a liquid at 90° C. (water was chosen as a liquid because the non-polymeric compound was a wax). Stir the liquid so that the specimen might not float (or a jig may be used to hold the specimen in the liquid). While in this test 175 ml of water was put in a 200 ml beaker, and one specimen weighting about 1 to 2 g was immersed therein, the amount of the liquid is not critical as long as the specimen is fully immersed in a sufficient amount of the liquid.
(c) After 10 minutes immersion, take out the specimen, put the specimen in a glass petri dish, and cool until the non-polymeric compound crystallizes. After wiping water off the surface of the specimen with, e.g., paper towel, put the specimen in a glass petri dish, and sufficiently remove water in a nitrogen gas flow in a constant temperature chamber at 105° C. for 3 hours under reduced pressure. The drying time is adjusted appropriately so as to remove water sufficiently.
(d) Cool the specimen taken out from the chamber to the crystallizing temperature of the non-polymeric compound, and measure the mass after the immersion.
(e) Calculate the mass reduction from ((mass before immersion−mass after immersion)/(mass before immersion×(R/100)))×100, where R is the ratio (mass %) of the non-polymeric compound to the total mass of the rubber and the non-polymeric compound.

TABLE 7

| | Example 2 | Example 3 | Example 4 | Example 5 |
|---|---|---|---|---|
| Mass Reduction (%) | 1.4 | 0.3 | 0.1 | 3.0 |

It is seen from Table 7 that the mass reduction is as small as 3 mass % or less. It is considered to be because of such a small mass reduction that the shape memory performance does not reduce with repetition of deformation as demonstrated in Table 3 or the like.

### INDUSTRIAL APPLICABILITY

As described, the invention provides a shape memory rubber molded article that exhibits excellent shape memory, provides a large freedom in setting a temperature at which the article having been held in a fixed deformed state is allowed to restore its original shape, and is producible easily and conveniently.

1. A shape memory rubber molded article comprising a mixture containing a rubber and a crystalline non-polymeric compound, the rubber in the molded article being crosslinked,
wherein a deformed state of the shape memory rubber molded article is fixed by crystallization of the non-polymeric compound, and the fixed, deformed state is released by melting of the non-polymeric compound.

2. The shape memory rubber molded article according to claim 1, wherein the non-polymeric compound is present in an amount of 10% to 90% by mass based on the total mass of the rubber and the non-polymeric compound.

3. The shape memory rubber molded article according to claim 1 or 2, wherein the rubber and the non-polymeric compound are present in finely divided separate phases.

4. The shape memory rubber molded article according to claim 1, having a mass reduction of 10% or less by mass when the article is immersed in a liquid which is maintained at or above the melting temperature of the non-polymeric compound and in which the non-polymeric compound is insoluble.

5. The shape memory rubber molded article according to claim 1, wherein the non-polymeric compound is a wax.

6. The shape memory rubber molded article according to claim 1, wherein the rubber is crosslinked by a crosslinking agent.

7. An intermediate composition for producing the shape memory rubber molded article according to claim 1, comprising a rubber and a crystalline non-polymeric compound,
the non-polymeric compound being in a crystallized state,
the rubber and the non-polymeric compound being present in finely divided separate phases, and
the rubber being uncrosslinked.

8. A shape memory rubber molded article obtained by kneading a rubber and a crystalline non-polymeric compound at a temperature lower than a melting completion temperature of the non-polymeric compound to prepare an intermediate composition and then crosslinking the rubber,
the melting completion temperature of the non-polymeric compound being determined by thermal analysis using a differential scanning calorimeter in accordance with JIS K7121 to obtain a melting curve, and the melting completion temperature corresponding to an intersection between a first tangent to a base line on the high temperature side of the melting peak and a second tangent to a slope of the melting curve located on the high temperature side of the melting curve, the second tangent being located at a point apart from that base line by ⅕ the height of the peak, wherein, when the melting curve has two or more peaks, the peak at the highest temperature is chosen to determine the melting completion temperature.

9. A process for producing an intermediate composition comprising the step of kneading raw materials comprising a rubber, a non-polymeric compound, and a crosslinking agent, the content of the non-polymeric compound being 10% to 90% by mass based on the total mass of the rubber and the non-polymeric compound, at a temperature lower than a melting completion temperature of the non-polymeric compound and lower than a crosslinking temperature of the crosslinking agent.

10. A process for producing a shape memory rubber molded article comprising the steps of kneading a rubber, a crystalline non-polymeric compound, and a crosslinking agent at a temperature lower than a melting completion temperature of the non-polymeric compound to prepare an intermediate composition, molding the intermediate composition, and crosslinking the rubber simultaneously with or after the molding.

11. The process for producing a shape memory rubber molded article according to claim 10, wherein the crosslinking is carried out simultaneously with the molding.
